(19) United States
(12) Patent Application Publication
(10) Pub. No.: US 2012/0132110 A1
(43) Pub. Date: May 31, 2012

(54) CONCENTRATE COMPOSITION FOR POLYMERS

(75) Inventors: Melinda Niederer-Bátorfi, Zutphen (NL); Marten Theodoor Ubbink, Apeldoorn (NL); Dominicus Wihelmus Raphaël Beekman, Steenenkamer (NL)

(73) Assignee: HOLLAND COLOURS N.V., Apeldoorn (NL)

(21) Appl. No.: 13/377,322

(22) PCT Filed: Jun. 8, 2010
(86) PCT No.: PCT/NL10/50349

§ 371 Date: Feb. 2, 2012

(30) Foreign Application Priority Data
Jun. 10, 2009 (EP) 09162451.0

(51) Int. Cl. C08K 3/22; C08K 3/32; C08K 3/08; B82Y 30/00

(52) U.S. Cl. 106/403; 106/429; 106/502; 106/450; 106/462; 977/773

(57) ABSTRACT

The invention is directed to a concentrate composition suitable for melt blending of nano particle size additives into polymers or polymer blends, said composition comprising a waxy matrix carrier material having an melting point of at least 40° C., in an amount of 10 to 99.9 wt. %, based on the weight of the composition and metal or metaloxide primary nanoparticles having a particle size substantially between 1 and 500 nm, wherein the metal oxide nano particles are zinc oxide or silver oxide.

The invention is directed to a concentrate composition suitable for melt blending of additives into polymers or polymer blends.

When preparing polymer products by extrusion or otherwise, usually additives are needed, either for colouring the final product and/or to provide the product with specific properties, such as improved mechanical properties, barrier properties antistatic properties, flame retardant properties, oxygen scavenging properties, anti-microbial properties and the like.

Usually the additives can be added pure or in the form of a masterbatch to the polymer or polymer blend. Using a masterbatch instead of a pure additive during a polymer process helps achieving better dispersion in the polymer system; however, this grade of dispersion is not always good enough. Using additive concentrates based on another, tailor-made matrix than the polymer itself can help further improve dispersion, which is necessary to exploit all possibilities of the corresponding additive.

Recently the use of nanosized additives has strongly increased. However, it has been found quite difficult to disperse these additives adequately throughout the polymer. Especially when it is required that the article remains transparent, the degree of dispersion is very important.

Accordingly it is an object of the present invention to provide a concentrate composition having improved properties for dispersing nanosized additive particles in polymers or polymer blends.

The invention is accordingly defined by a concentrate composition suitable for melt blending of nano particle size additives into polymers or polymer blends, said composition comprising a waxy matrix carrier material having an melting point of at least 40° C., in an amount of 10 to 99.9 wt. %, based on the weight of the concentrate composition, and metal or metaloxide primary nanoparticles having a particle size substantially between 1 and 500 nm, wherein the metal oxide nano particles are zinc oxide or silver oxide.

Surprisingly it has been found that the use of waxy material as matrix carrier material in a concentrate composition of metal nano particles or metal oxide nano particles of zinc oxide and silver oxide, optionally supported of encapsulated, makes it possible to provide polymer nanocomposite materials having strongly improved properties, compared to materials that have been produced using other types of concentrate compositions.

The main components of the concentrate composition are the nano particle additive and the waxy matrix material.

The waxy material may be selected from natural, synthetic and modified natural waxes. A practicable definition for waxes was developed by the M-Wax Department of the German Society for Fat Science (Deutsche Gesellschaft für Fettwissenschaft or DGF for short), first published in 1957 and revised in 1974: “Wax is a technical collective designation for a series of natural or artificially produced materials that have the following characteristics:

kneadable at 20° C.,
firm to brittle hard,
coarsely to finely crystalline,
translucent to opaque, but not glassy,
melts above 40° C., without breaking down,
relatively low viscosity already just above the melting point, consistency and solubility heavily dependent on temperature,
polishable under light pressure.”

In general, waxes are classified as follows:

Natural waxes: Animal, vegetable, and mineral in origin.
Artificial waxes: Chemically modified waxes/semisynthetic waxes, where an existing wax molecule is chemically modified, more specifically modified oils, such as hydrogenated oils.
Synthetic waxes: A wax is built up on a low-molecular, non-waxy molecule or by decomposition of a macro-molecular plastic.

According to a preferred embodiment the waxy material has been selected from the group of synthetic and artificial waxes, more in particular selected from the group of polyethylene wax, oxidised polyethylene wax, amide wax, ester wax, hydrogenated oil and combinations thereof. These waxes have shown to be especially suitable as matrix material for incorporating nano particle additives into polymer or polymer blend compositions.

In general the nano particle additive can be any additive having the required particle size. This particle size is preferably defined thereon that substantially all primary particles are within the specified range. This can be expressed in such a way that at least 95% of the number of particles is within the specific range. In the broadest sense, this range is between 1 and 500 nm, preferably between 1 and 100 nm.

The definition is based on the size of the primary particles. These particles sometimes have a tendency to form loose agglomerates. However, for the determination of the size and often also of the properties, the primary particles are important and not the agglomerate. In addition, in the case the particles are used on a (generally microsize) support, the support is not taken into consideration for the determination of the size.

The method of determining the size of the nano particles is defined in the examples.

The nano particle additive is selected among the group of metals, and zinc oxide and silver oxide as metal oxides. More in particular the nanoparticles have been selected from silver, iron, gold, copper, nickel, cobalt, cerium, palladium, zinc and titanium metal. Depending on the nature of the additive, specific properties may be imparted to the polymer composition, as will be explained later on.

It is to be noted that in general the nanoparticles are used as such. However, it is also possible to use supported, encapsulated and/or coated nanoparticles.

The amount of waxy material in the concentrate composition may vary widely. In the broadest sense it may be between 1 and 99.9 wt. %. The actual amount can easily be determined on the basis of the specific application and kind of additive. Preferred ranges are between 25 and 99.9 wt. %, more in particular between 50 and 99.9 wt. %.

The concentrate may be used with every suitable polymer or polymer blend into which the additive has to be incorporated. Examples of these polymers are polyolefines (such as PE, PP, HDPE, LDPE), polycarbonates (PC), polyacrylates (such as PMMA), styrene polymers (such as PS, EPS, XPS, ABS, SAN), polyamides (6,46,66,T4), polyimides, biopolymers (such as polylactide and the like), polyesters (such as PET, PEN, PBT), optionally in fibre form, polyacetales, POM, vinylchloride polymers (such as PVC), natural and synthetic elastomers, such as silicone based elastomers or EP-based elastomers, thermoplastic elastomers and blends of two or more of these polymers.

The concentrates of the present invention show improved performance contrary to already on the markt accessible nano based masterbatches. The concentrates avoid reagglomeration of nanoparticles resulting in stable performance, when dispersed into a polymer or polymer blend.

As indicated above, the addition of nanoparticle additives to polymers or polymer blends can be used to impart specific properties to the said polymers or polymer blends.

Examples thereof are enhanced biocide activity (antimicrobial, antibacterial, antifungal) by the use of Ag, Ag₂O; ZnO; nano metal (such as nano silver or silver oxide,) doped materials, ZnO doped alumina, nano silver or silver oxide doped silica/alumina mixture, nano silver or silver oxide containing ceramic materials, silver containing zinc oxide or zirconia composite.

Anorganic biocide additives may be used, which utilize the natural power of silver or other above named nanoparticles to protect a wide variety of products against bacteria, fungus, mold, yeasts or/and other microbes.

Enhanced, permanent UV absorption and/or wheatherability is provided by ZnO.

ZnO is used for enhancing anti scratch properties and for providing biostatic effects. Antistatics properties can be created by the use of Ag and silver doped materials. In addition thereto it may be possible to use additives imparting IR-absorption, superconductivity composite, for example by the use of nano metal doped salts, decreased refractive index, and the like. In addition one may also use nano metals or metal oxides as pigment, such as nano gold.

The nano particles may be used as such or on a support material, which are also called nano metal doped materials, or in encapsulated form. Usually this support material will be a support, i.e. a support having a size in the micrometer range. Preferred supports are ceramics, hydroxyapatites, silica, alumina and/or metal salts such as hydroxides, carbonates, halides, sulphates and/or phosphates, e.g. tricalcium phosphate or zirconium phosphate.

Usually this support material can be a micro or nanosized support, i.e. a support having a size in the micrometer range, such as between 1 and 500 micron, or less than 1 micrometer.

The nanoparticle concentrates may further contain additional additives, optionally not in the nano particle size range. These additives may be selected from the group of colourants, strengthening agents, UV absorbers, AA scavengers, oxygen scavengers, antislip agents, flame retardants and antistatic agents.

The invention is further directed to a process for the preparation of a concentrate composition suitable for melt blending of nano particle size additives into polymers or polymer blends, comprising the dispersion of metal or metaloxide primary nanoparticles having a particle size substantially between 1 and 500 nm (which nanoparticles are optionally supported and/or coated), into a waxy material having a melting point of at least 40° C., at a temperature above the said melting point, shaping and cooling the dispersion thus obtained to form solid particles.

In yet a further embodiment the invention is directed to a polymer nano composite based on at least one polymer and the nanoparticle concentrate defined herein. The amount of the concentrate used therein will be between 0.1 and 50 wt. %.

The invention is now elucidated on the basis of some examples, which are not intended to limit the invention.

### EXAMPLES

Nano ZnO concentrate is based on 40 nm ZnO powder (CAS 1314-13-2); its purity is 99+%.

The Average Particle Size (APS) of ZnO is 40-100 nm; determined from SSA (specific surface area). BET (nitrogen gas adsorption) is used to determine the specific surface area. A formula is used to convert this value to an Average Particle Diameter (APD) in nanometers. The SSA of this type of ZnO can vary between 100 to 2518 m²/g depend on particle size, as particle size is a primary determinant of surface area supposing no existence of pores inside the particles. The average particle diameter, D, is given by: D=6/(Sₛₚ*ρₐ), where Sₛₚ is the specific surface area (SSA) per unit mass of the sample and ρₐ is the true density by assuming all particles to have the same spherical shape and size. APD and/or APS (Average Particle Size) can be used interchangeably. This method gives no information about the particle size distribution (PSD). Particle sizes and distributions can be determined also by image analysis, laser diffraction and/or DLS (dynamic light scattering) techniques.

Nano ZnO concentrate was prepared from 30 wt. % of 40 nm ZnO powder (CAS 1314-13-2) and 70 wt. % PE wax, having a melting point of 108-112° C. The ZnO was dispersed during 24 hours in the molten wax by standard dispersion process technics, at a temperature of 110° C. The dispersion thus obtained was shaped and cooled to room temperature in order to form solid particles.

The 40 nm ZnO powder and the nano ZnO concentrate was incorporated into a transparent ABS in 0.1 wt % on a two roll mill in several concentrations. The resulted transparent ABS sheets were visually examined on haziness. The transparent ABS sheets containing pure ZnO powder were substantially more hazy than transparent ABS sheets containing the nano ZnO concentrate at the same level of ZnO loading.

The same experiments were done using pure on zirconium phosphate based silver material (Ag—ZrP) and Ag—ZrP concentrate in transparent polycarbonate by injection molding. Also in this case a visual examination of the injection molded parts showed that the parts based on the concentrate were substantially less hazy than the others.

Haziness measurements of the thus prepared polymer chips were collected using Minolta CM 3600D equipment, the transmittance [%] using Carry 5000 type spectrophotometer with an integrating sphere. The dispersion quality of the nanoparticle concentrates differs between concentrate 1 and concentrate 2, but the compositions remains the same as described above. Namely, concentrate 2 has a more fine quality by dispersing it for longer time. The comparison was made between the incorporated pure nanoparticles and the incorporated concentrate compositions vs the reference natural polymer transparent ABS (type Terlux 2802TR) or PC (type Makrolon 3105). Table 1 shows the haze [%] and transmittance [%] results of the thus obtained polymer.

TABLE 1

| | additive | | Transmittance | |
|---|---|---|---|---|
| | concentration | haze | [%] | sample |
| sample | in composite | [%] | at 400 nm | thickness |
| trABS (naturel) | — | 2.20 | 82.0 | 1.5 mm |
| trABS/ZnO (60 nm) | 1500 ppm ZnO | 18.68 | 45.6 | 1.5 mm |
| (pure) | | | | |
| trABS/ZnO (60 nm) | 1500 ppm ZnO | 10.68 | 65.5 | 1.5 mm |
| concentrate 1 | | | | |
| trABS/ZnO (60 nm) | 1500 ppm ZnO | 6.30 | 70.5 | 1.5 mm |
| concentrate 2 | | | | |
| trABS/ZnO (30 nm) | 1500 ppm ZnO | 12.43 | 61.7 | 1.5 mm |
| (pure) | | | | |
| trABS/ZnO (30 nm) | 1500 ppm ZnO | 9.97 | 72.7 | 1.5 mm |
| concentrate 1 | | | | |
| trABS/ZnO (30 nm) | 1500 ppm ZnO | 3.78 | 76.5 | 1.5 mm |
| concentrate 2 | | | | |

TABLE 2

| | additive | | Transmittance | |
|---|---|---|---|---|
| | concentration | haze | [%] | sample |
| sample | in composite | [%] | at 400 nm | thickness |
| PC (naturel) | — | 0.37 | 83.5 | 2 mm |
| PC/AgZrP (pure) | 1000 ppm AgZrP | 49.78 | 68.9 | 2 mm |
| PC/AgZrP | 1000 ppm AgZrP | 31.75 | 76.3 | 2 mm |
| concentrate 1 | | | | |

As can be seen, the haziness decreases, whereas the transmittance increases by increasing dispersion quality versus polymer chips containing pure ZnO nanoparticles.

Table 2 presents the haziness and transmittance data of pure and concentrate Ag—ZrP containing polycarbonate (type Makrolon 3105) chips. Similar to the findings of Table 1, the results of concentrate Ag—ZrP improved contrary to that of the pure Ag—ZrP.

The Ag—ZrP is an commercial available material (Alphasan), which is known of its antibacterial activity. The concentrate formulation did not lose its antibacterial activity, while at the same time improved haziness and transmittance could be observed.

The testing of material samples for antibacterial activity was carried out according to JIS Z 2801:2000 norm, which determines the measurement of antibacterial activity on plastics surfaces. Two test strains were used Staphylococcus aureus AATCC 6538 as gram positive bacteria and Escherichia coli DSM498 as gram negative bacteria.

The following Tables 3, 4 present the tested sample composition and the obtained results. Calculation of value of titer reduction has been calculated in relation to initial amount of bacteria based on (T₀-T₂₄)/T₀.

TABLE 3

| | test strain | Staphylococcus aureus AATCC 6538 | | | |
|---|---|---|---|---|---|
| | concentration in | initial | titer after 24 h | | |
| sample | polymer | titer [cfu] | [cfu] | titer reduction | Interpretation |
| PC (naturel) | — | 6.30E+05 | 5.30E+07 | — | no aa |
| composite PC/Ag—ZrP (pure) | 1000 ppm Ag | 6.30E+05 | 1.80E+05 | 71.43% | good aa |
| composite PC/Ag—ZrP concentrate 1 | 1000 ppm Ag | 6.30E+05 | 2.60E+05 | 58.73% | good aa |

Abbreviation:
aa antimicrobial activity

TABLE 4

| | test strain | Eschericia coli DSM 498 | | | |
|---|---|---|---|---|---|
| | concentration in | initial | titer after 24 h | | |
| sample | polymer | titer [cfu] | [cfu] | titer reduction | Interpretation |
| ABS (naturel) | — | 5.20E+05 | 1.90E+07 | — | no aa |
| composite ABS/Ag—ZrP (pure) | 1000 ppm Ag | 6.10E+05 | 2.30E+05 | 62.30% | good aa |
| composite ABS/Ag—ZrP concentrate 1 | 1000 ppm Ag | 6.10E+05 | 2.70E+05 | 55.74% | good aa |

Abbreviation:
aa antimicrobial activity

As can be seen, good antibacterial effectiveness could be maintained against both Staphylococcus aureus and Escherichia coli bacteria.

1. A concentrated composition suitable for melt blending of nanoparticle size additives into polymers or polymer blends, said composition comprising a waxy matrix carrier material having an melting point of at least 40° C., in an amount of 10 to 99.9 wt. %, based on the weight of the composition and metal or metal oxide primary nanoparticles having a particle size substantially between 1 and 500 nm, wherein the metal oxide nanoparticles are zinc oxide or silver oxide.

2. The composition according to claim 1, wherein the waxy material is selected from the group consisting of natural, synthetic and modified natural waxes.

3. The composition according to claim 1, wherein the nanoparticles are selected from the group consisting of silver, iron, gold, copper, nickel, cobalt, cerium, palladium, zinc and titanium metal.

4. The composition according to claim 1, wherein the particle size of the primary nanoparticles is substantially between 1 and 100 nm.

5. The composition according to claim 1, wherein at least 95% by number of the primary nanoparticles is within the indicated size range.

6. The composition according to claim 1, wherein the composition additionally contains other additives.

7. The composition according to claim 6, wherein the said additives are selected from one or more compounds from the group consisting of colourants, strengthening agents, UV absorbers, AA scavengers, oxygen scavengers, antislip agents, flame retardants and antistatic agents.

8. The composition according to claim 1, wherein the primary nanoparticles are supported on a solid support.

9. The composition according to claim 8, wherein silver or silver oxide nano particles are supported on or encapsulated in zirconium or tricalcium phosphate.

10. The composition according to claim 8, wherein silver or silver oxide nano particles are silver containing zinc oxide or zirconia composites.

11. The composition according to claim 1, wherein the nanoparticles are coated.

12. The composition according to claim 1, wherein the composition is obtainable by the dispersion of the said metal or metaloxide primary nanoparticles into the said waxy material at a temperature above the melting point of the waxy material, shaping and cooling the concentrate thus obtained to form solid particles.

13. A process for the preparation of a concentrate composition suitable for melt blending of nano particle size additives into polymers or polymer blends, comprising the dispersion of metal or metaloxide primary nanoparticles having a particle size substantially between 1 and 500 nm, into a waxy material having a melting point of at least 40° C., at a temperature above the said melting point, shaping and cooling the concentrate thus obtained to form solid particles.

14. The composition of claim 2 wherein the waxes are selected from the group consisting of polyethylene wax, oxidised polyethylene wax, amide wax, ester wax, hydrogenated oil and combinations thereof.

15. The composition of claim 8 wherein the solid support is selected from the group consisting of ceramics, hydroxyapatites, silica, alumina and metal salts and combinations thereof.

16. The composition of claim 15 wherein the metal salts are hydroxides, carbonates, halides, sulphates and/or phosphates.
